(19) United States
(12) Patent Application Publication
(10) Pub. No.: US 2024/0135185 A1
(43) Pub. Date: Apr. 25, 2024

(54) HIGH DIMENSIONAL SURROGATE MODELING FOR LEARNING UNCERTAINTY

(71) Applicants: International Business Machines Corporation, Armonk, NY (US); Ramot at Tel Aviv University Ltd., Tel-Aviv (IL)

(72) Inventors: Shashanka Ubaru, Ossining, NY (US); Paz Fink Shustin, Tel-Aviv (IL); Lior Horesh, North Salem, NY (US); Vasileios Kalantzis, White Plains, NY (US); Haim Avron, Tel Aviv (IL)

(21) Appl. No.: 18/167,381

(22) Filed: Feb. 10, 2023

(30) Foreign Application Priority Data
Oct. 13, 2022 (GR) 20220100845

(51) Int. Cl. G06N 3/088; G06N 3/04; G06N 3/0455

(52) U.S. Cl. CPC G06N 3/088; G06N 3/0418; G06N 3/0455

(57) ABSTRACT

A method to determine data uncertainty is provided. The method receives a high dimensional data input and a corresponding data output. The method trains a variational autoencoder (VAE) with the high dimensional data input to learn a low dimensional latent space representation of the high dimensional data input. An encoder part of the VAE outputs a set of distributions of the high dimensional dataset in a latent space. The method samples new data samples in the latent space using the set of distributions outputs from the encoder part of the VAE. The method learns a polynomial chaos expansion to map the new data samples in the latent space to the corresponding data output to learn the set of distributions and their relation to perform estimation with high-dimensional dataset under uncertainty such as missing values by estimating the values using the set of distributions.

### STATEMENT REGARDING PRIOR DISCLOSURES BY THE INVENTOR OR A JOINT INVENTOR

The following disclosure(s) are submitted under 35 U.S.C. § 102(b)(1)(A):
DISCLOSURE(S): “PCENet: High Dimensional Surrogate Modeling for Learning Uncertainty”, Shustin et al., 11 Feb. 2022, pp. 1-15, https://arxiv.org/abs/2202.05063.

### BACKGROUND

The present invention generally relates to artificial intelligence, and more particularly to high dimensional surrogate modeling for learning uncertainty.

Given dataset (x₁, y₁), . . . , (xₙ, yₙ), the goal is to learn functional mapping between the distributions of the input and output data.

In many situations, the tasks of learning data representation also need to account for the uncertainty in the data (due to noise, training and testing data mismatch, incomplete data, class overlap, discordant, multi-modal data and more).

Learning data representations under uncertainty is an important task that emerges in numerous machine learning applications. However, uncertainty quantification (UQ) techniques are computationally intensive and become prohibitively expensive for high-dimensional data.

### SUMMARY

According to aspects of the present invention, a method of mapping high dimensional input data to a low dimensional latent representation to determine data uncertainty is provided. The method includes receiving, by a computing device, a high dimensional data input and a corresponding data output. The method further includes training, by the computing device, a variational autoencoder (VAE) with the high dimensional data input to learn a low dimensional latent space representation of the high dimensional data input. An encoder part of the VAE outputs a set of distributions of the high dimensional dataset in a latent space. The method further includes sampling, by the computing device, new data samples in the latent space using the set of distributions outputs from the encoder part of the VAE. The method additionally includes learning, by the computing device, a polynomial chaos expansion to map the new data samples in the latent space to the corresponding data output to learn the set of distributions and their relation to perform estimation with high-dimensional dataset under uncertainty such as missing values by estimating the values using the set of distributions.

According to other aspects of the present invention, a computer program product for mapping high dimensional input data to a low dimensional latent representation to determine data uncertainty is provided. The computer program product includes a non-transitory computer readable storage medium having program instructions embodied therewith. The program instructions are executable by a computing device to cause the computing device to perform a method. The method includes receiving, by the computing device, a high dimensional data input and a corresponding data output. The method further includes training, by the computing device, a variational autoencoder (VAE) with the high dimensional data input to learn a low dimensional latent space representation of the high dimensional data input. An encoder part of the VAE outputs a set of distributions of the high dimensional dataset in a latent space. The method also includes sampling, by the computing device, new data samples in the latent space using the set of distributions outputs from the encoder part of the VAE. The method additionally includes learning, by the computing device, a polynomial chaos expansion to map the new data samples in the latent space to the corresponding data output to learn the set of distributions and their relation to perform estimation with high-dimensional dataset under uncertainty such as missing values by estimating the values using the set of distributions.

According to still other aspects of the present invention, a computer processing system for mapping high dimensional input data to a low dimensional latent representation to determine data uncertainty is provided. The computer processing system includes a memory device for storing program code. The computer processing system further includes a hardware processor operatively coupled to the memory device for running the program code to receive a high dimensional data input and a corresponding data output. The hardware processor further runs the program code to train a variational autoencoder (VAE) with the high dimensional data input to learn a low dimensional latent space representation of the high dimensional data input. An encoder part of the VAE outputs a set of distributions of the high dimensional dataset in a latent space. The hardware processor also runs the program code to sample new data samples in the latent space using the set of distributions outputs from the encoder part of the VAE. The hardware processor additionally runs the program code to learn a polynomial chaos expansion to map the new data samples in the latent space to the corresponding data output to learn the set of distributions and their relation to perform estimation with high-dimensional dataset under uncertainty such as missing values by estimating the values using the set of distributions.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a computing environment, in accordance with an embodiment of the present invention;

FIGS. 2-3 are flow diagrams showing exemplary method of using a neural network to determine a mapping between data input into a machine learning model and data output from the machine learning model, in accordance with an embodiment of the present invention;

FIG. 4 is a diagram showing exemplary pseudocode, in accordance with an embodiment of the present invention;

FIG. 5 is flow diagram showing another exemplary method of using a neural network to determine a mapping between data input into a machine learning model and data output from the machine learning model, in accordance with an embodiment of the present invention;

FIG. 6 is a diagram showing an exemplary computer vision scenario 600 to which the present invention can be applied, in accordance with an embodiment of the present invention.

### DETAILED DESCRIPTION

Embodiments of the present invention relates to high dimensional surrogate modeling for machine learning under uncertainty.

Embodiments of the present invention can address the goal of learning the functional relation between the input and output of a high dimensional data system under uncertainty.

Embodiments of the present invention present a novel surrogate model for representation learning and uncertainty quantification, which aims to deal with data of moderate to high dimensions (i.e., greater than 100 dimensions). The proposed model combines a neural network approach for dimensionality reduction of the (potentially high-dimensional) data, with a surrogate model method for learning the data distribution. Embodiments of the present invention first employ a variational autoencoder (VAE) to learn a low-dimensional representation of the data distribution. Low dimensional denotes about 10 dimensions and certainly not more than 20. Embodiments of the present invention then propose to harness polynomial chaos expansion (PCE) formulation to map this distribution to the output target. The coefficients of PCE are learned from the distribution representation of the training data using a maximum mean discrepancy (MMD) approach. Our model enables us to (a) learn a representation of the data, (b) estimate uncertainty in the high-dimensional data system, and (c) match high order moments of the output distribution; without any prior statistical assumptions on the data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

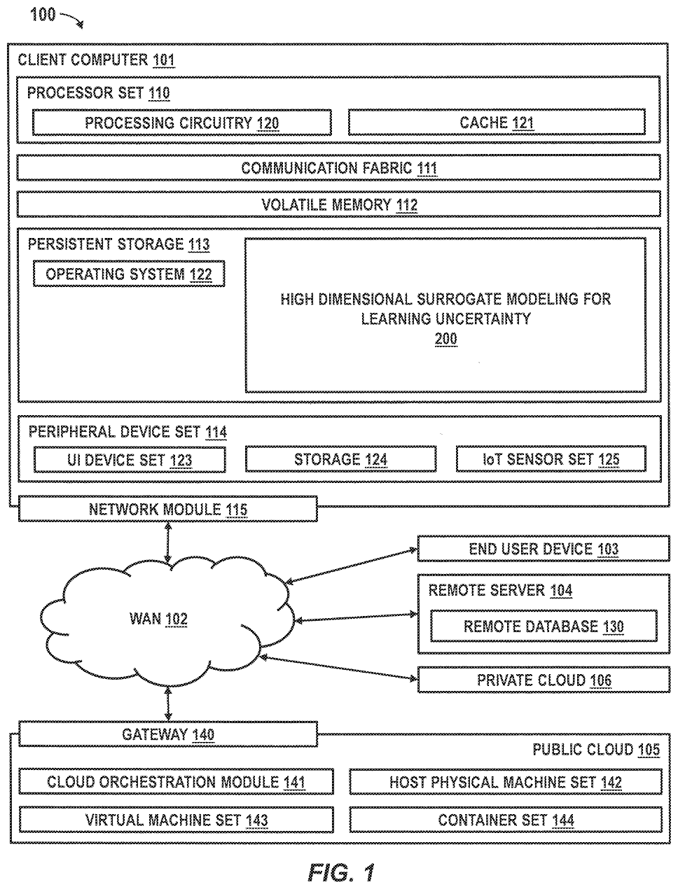

FIG. 1 is a block diagram of a computing environment 100, in accordance with an embodiment of the present invention.

Computing environment 100 contains an example of an environment for the execution of at least some of the computer code involved in performing the inventive methods, such as high dimensional surrogate modeling for learning uncertainty. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the interne. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

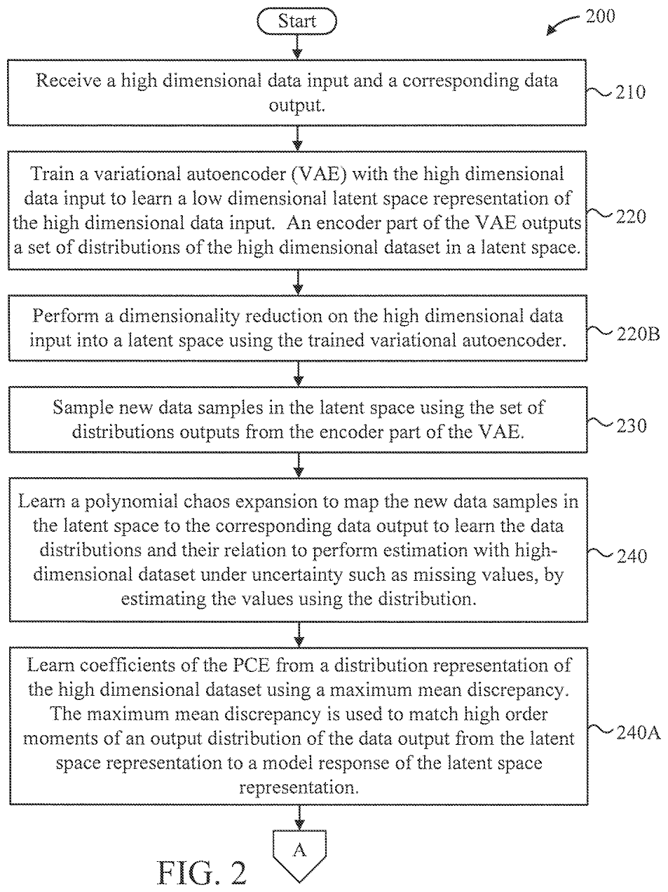

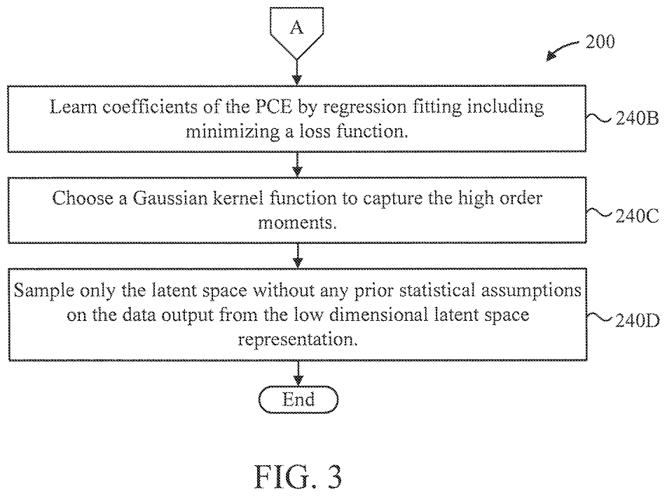

FIGS. 2-3 are flow diagrams showing exemplary method 200 of using a neural network to determine a mapping between data input into an intermediate latent space representation with low dimension and data output from the machine learning model, in accordance with an embodiment of the present invention. The idea is to a VAE to learn a latent space (low dimensional) representation of the input data. Then, this latent space representation is used as input to PCE to learn the relation to the output.

At block 210, receive a high dimensional data input and a corresponding data output.

At block 220, train a variational autoencoder (VAE) with the high dimensional data input to learn a low dimensional latent space representation of the high dimensional data input. An encoder part of the VAE outputs a set of distributions of the high dimensional dataset in a latent space.

In an embodiment, block 220 can include block 220A.

At block 220A, perform a dimensionality reduction on the high dimensional data input into a latent space using the trained variational autoencoder.

At block 230, sample new data samples in the latent space using the set of distributions outputs from the encoder part of the VAE.

At block 240, learn a polynomial chaos expansion to map the new data samples in the latent space to the corresponding data output to learn the data distributions and their relation to perform estimation with high-dimensional dataset under uncertainty such as missing values, by estimating the values using the distribution.

In an embodiment, block 240 can include one or more of blocks 240A through 240D.

At block 240A, learn coefficients of the PCE from a distribution representation of the high dimensional dataset using a maximum mean discrepancy. The maximum mean discrepancy is used to match high order moments of an output distribution of the data output from the machine learning model to a model response of the machine learning model.

At block 240B, learn coefficients of the PCE by regression fitting including minimizing a loss function.

At block 240C, choose a Gaussian kernel function to capture the high order moments.

At block 240D, sample only the latent space without any prior statistical assumptions on the data output from the low dimensional latent space representation.

Embodiments of the present invention are directed to a surrogate modeling approach to learn representations of high-dimensional data systems under uncertainty. Our approach is to learn the functional mapping between the distributions of the input and output data, where both distributions could be unknown a-priori. This assists in data uncertainty modeling and propagation, as well as in promoting generalizability. The proposed method comprises of two stages. In the first stage, we map the (possibly high-dimensional) input data distribution to a low dimensional latent distribution using a NN approach. Then, in the second stage, a surrogate model is trained to learn a mapping between the latent and the output distributions. For the dimensionality reduction stage, we employ Variational Autoencoders (VAE), a NN-based Bayesian unsupervised learning approach. VAE embeds/maps the (possibly unknown) input data distribution to a normal distribution in a lower latent dimension, enabling us to use a suitable surrogate model to map the latent space to the output. VAE also helps in uncertainty propagation, and has recently been used for input data uncertainty quantification.

In the surrogate modeling stage, we consider Polynomial Chaos Expansions (PCEs) to learn the mapping from the latent distribution to the output space. PCEs are highly efficient uncertainty modeling techniques and have many appealing properties, including: (a) they are inexpensive to compute; (b) they can match higher-order moments, making them suitable for arbitrary distributions with arbitrary probability measures; and (c) they capture the global characteristic of the function. We propose a maximum mean discrepancy (MMD) approach to learn the coefficients of PCE from the training data. MMD is a moment matching technique, and therefore, enables us to match high order moments of the output distribution to the model response. Moreover, our approach only requires sampling the latent distribution, and does not require any prior statistical assumptions on the data.

In the learning set-up, we have a dataset (x₁, y₁), . . . , (xₙ, yₙ) where {xᵢ}ᵢ₌₁ⁿ∈X⊆ [symbol] ^{m} and {yᵢ}ᵢ₌₁ⁿ∈X⊆ [symbol] , and a function F:X→Y, parameterized by ρ (that may depend on the priors of {X, Y}), such that the observations satisfy yᵢ=F(xᵢ, ρ). We assume that F is expensive to evaluate, and thus our goal is to build a cheap-to-compute function \tilde{F}: [symbol] ^{m}→ [symbol] that approximates F well with respect to ρ, e.g., |F−\tilde{F}| has a small ρ-weighted [symbol] 2 norm, which is expensive to evaluate. Our proposed model consists of two stages. In the first stage, we use a dimensionality reduction function E: [symbol] ^{m}→ [symbol] ^{d} that maps {x₁, . . . , xₙ} to {z₁, . . . , zₙ} of a lower dimension with a new distribution η. Here, we set the latent dimension (a hyperparameter) d to be much smaller than the input dimension m. The function E will hence be the encoder part of VAE. In the second stage, we construct a family of multivariate polynomials {ϕj}N j=1 which are orthogonal with respect to the distribution η, and the coefficients of the corresponding PCE are learned using the MMD approach (a kernel regression task) in order to map {z₁, . . . , zₙ} to {y₁, . . . , yₙ}. The PCE function P: [symbol] ^{d}→ [symbol] has an expansion of the form

$$\\ P ( z ) = {\sum }_{j = 1}^{N} {c}_{j} {φ}_{j} ( z ) ,$$

where φⱼ(·)'s are the orthogonal polynomials and cⱼ's are coefficients learned using the MMD approach. Therefore, the proposed surrogate model can be written as \tilde{F}(x)=P∘E(x)=P(z).

A description will now be given regarding notations, in accordance with an embodiment of the present invention.

We will follow the standard notation of lowercase, bold lowercase and bold uppercase letters for scalars x, vectors x, and matrices X, respectively. Probability vector spaces are denoted using bold calligraphic letters X and functions using uppercase letters F (·). DKL denotes the Kullback-Leibler divergence (KL-divergence), and fx(·) denotes the joint probability density function with X. Finally, N (μ, Σ) denotes the multivariate Gaussian distribution with mean vector μ and covariance matrix Σ.

A description will now be given regarding the VAE.

VAE is an unsupervised learning technique based on dimensionality reduction and variational inference (VI). VAE includes two parts. The first part is the encoder parameterized by φ which takes input x∈R^{m} and returns a distribution on the latent variable z∈R^{d}, where d<m. The second part is the decoder parametrized by θ which tries to reconstruct x from the samples of the latent distribution. Together with VI, the encoder is the inference model and the decoder is the generative model. These two parts/NNs are jointly optimized in order to maximize the evidence lower bound (ELBO):

$$\\ \begin{matrix}ℒ ( θ , ϕ ; x ) = Eq [ ln {p}_{θ} ( x , z ) - ln {q}_{ϕ} ( z \vert x ) ] = ln p ( x ) - {D}_{KL} [ {q}_{ϕ} ( z \vert x ) ‖ p ( z \vert x ) ] \leq ln p ( x ) & ( 1 )\end{matrix}$$

where ln p(x) is the marginal likelihood, and DKL is the KL-divergence.

An intractable posterior distribution pθ(z|x) of a latent variable model pθ(x, z)=pθ(x|z)p(z) is approximated by a guide qφ(z|x). The approximation, qφ(z|x), is performed by taking qφ(z|x) to be a simple distribution, e.g., Gaussian with a diagonal covariance N (μ(x), Σ(x)).

The parameters of qφ(z|x) are estimated by maximizing Eq. (1). In VAE, the encoder outputs qφ(z|x) by returning μ(x) and (the diagonal elements of) Σ(x), and then z is sampled and passed through the decoder which allows the optimization of the ELBO.

Importantly, ELBO can also be written as follows:

L(θ,φ;x)= [symbol] _{q}[ln p_{θ}(x|z)]−D_{KL}[q_{ϕ}(z|x)∥p(z)] (2)

where p(z) is some predetermined prior distribution. The term D_{KL}[q_{ϕ}(z|x)∥p(z)] can be viewed as a regularization term which forces q_{ϕ}(z|x) to be approximately distributed as the prior p(z), which is independent of x. Thus, q_{ϕ}(z) is approximately distributed as the prior. Typically, the prior is chosen to be p(z)= [symbol] (0, I).

A description will now be given regarding Polynomial Chaos Expansion (PCE), in accordance with an embodiment of the present invention.

Polynomial Chaos Expansion (PCE) is an inexpensive surrogate model that aims to map uncertainty from an input space X⊆ [symbol] ^{m} to an output space y⊆ [symbol] . The uncertainty is expressed through a probabilistic framework using random vectors, i.e., Y=P(X) where X∈X with a given joint probability density function (PDF)ƒx(·) and P(·) is a sum of polynomials that are typically orthogonal with respect to the measure ƒx. In contrast to other probabilistic methods such as Gaussian processes, PCEs approximate the global behavior of the model using a set of orthogonal polynomials. It is also assumed that Y has a finite variance [symbol] [Y²]<∞, and that each component of X has finite moments of any order.

Thus, the space of square integrable functions with respect to the weighted function ƒx(·) can be represented by an orthonormal basis of polynomials {φᵢ(·)}_{i∈N}_{^{m}}:

∫ₓ{φᵢ(x)φⱼ(x)ƒx(x)=δᵢⱼ (3)

Therefore, Y can be represented as follows:

Y=P(X)=Σ_{j∈N}_{^{m}}cⱼφⱼ(X) (4)

The coefficients cⱼ in Equation (4) are usually computed using a data driven regression approach. Given a dataset of observations (x₁, yᵤ), . . . , (xₙ, yₙ)∈X×Y, the coefficients can be found by regression fitting, such as by minimizing the L₂ loss function as follows:

$$\\ {\sum }_{i = 1}^{n} {( {y}_{i} - P ( {x}_{i} ) )}^{2} .$$

Crucially, the orthonormality of the basis implies that the squared sum of the PCE coefficients typically displays rapid decay, which in turn reduces the number of coefficients actually required and thus avoids overfitting.

Furthermore, in the case where the components of X are independent and identically distributed, the polynomials in Equation (4) are composed of univariate polynomials by tensor product:

φⱼ(X)=Πₖ₌₁^{m}φⱼ_{ₖ}^{(k)}(Xₖ) (5) (k)

where φⱼ_{ₖ}^{(k)} is the jₖ polynomial in the k-th dimension. Since using the series (4) is not practical, PCE (Pik is used as a surrogate that replaces the true model in practice. This is done by truncating the series such that |j|=Σₖ₌₁^{N}jₖ≤N:

P_{N}(X)=Σⱼ₌₁^{N}^{ₚ}cⱼφⱼ(X) (6)

where the number of coefficients is

$$\\ {N}_{p} = \frac{( N + m ) !}{N ! m !} .$$

It can be seen that for a large dimension m, the process becomes prohibitively expensive.

A metric for measuring distances between distributions in terms of mean embedding is termed maximum mean discrepancy (MMD). Let H be a reproducing kernel Hilbert space (RKHS) over the domain X and K: X×X→ [symbol] be the associated kernel. Denote μ_{η}=E_{x˜η}[K(x, ·)] as the kernel mean of a given probability measure η over X. Then, for two probability measures η and v over X, with mean embeddings μ_{η} and μᵥ, respectively, the MMD is:

MMD(η,v)=∥μ_{η}−μᵥ∥_{H}²

and can also be expressed as

MMD(η,v)= [symbol] _{η}[K(x,x′)]−2 [symbol] _{η,v}[K(x,y)]+ [symbol] ᵥ[K(y,y′)]

where x, x′˜η and y, y′˜v. It can be seen that MMD is zero only if the two distributions are equal.

Given two sets of samples X={xᵢ}ᵢ₌₁ⁿ^{₁} and Y={yᵢ}ᵢ₌₁ⁿ^{₂}, one may ask whether their distributions η and v are the same. For that purpose, an empirical estimate of MMD can be obtained by the following:

$$\\ \begin{matrix}{L}_{{MMD}^{{}^{} 2}} = \frac{1}{{n}_{1}^{{}^{} 2}} {\sum }_{i , j = 1}^{{n}_{1}} K ( {x}_{i} , {x}_{j} ) - \frac{2}{{n}_{1} {n}_{2}} {\sum }_{i = 1}^{{n}_{1}} {\sum }_{j = 1}^{{n}_{2}} K ( {x}_{i} , {y}_{j} ) + \frac{1}{{n}_{2}^{{}^{} 2}} {\sum }_{i , j = 1}^{{n}_{2}} K ( {y}_{i} , {y}_{j} ) & ( 7 )\end{matrix}$$

Note that, as a consequent, the resulting kernel mean may incorporate high order moments of η. For example, when the kernel K(·, ·) is linear, [symbol] _{η}[K]=μ_{η} is simply the mean of η. Thus, choosing a Gaussian kernel allows us to capture high-order moments, and MMD acts as a moment matching approach.

A description will now be given regarding the first stage.

The objective of the first stage is to learn a low dimensional latent space representation of input data.

Dimensionality reduction: train a Variational Autoencoder (VAE) 210 for learning a distribution of the input data x₁, . . . , xₙ∈ [symbol] ^{m} in a low-dimensional latent space in [symbol] ^{d}. Generate posterior distributions ƒ_{z|x}_{₁}= [symbol] (μ₁, σ₁²), . . . ƒ_{z|x}_{ₙ}= [symbol] (μₙ, σₙ²) from the encoder E_{ϕ}(·) corresponding samples z₁, . . . , zₙ from each distribution. The VAE 210 includes an neural network encoder 211 and a neural network decoder 212.

The corresponding loss used by the VAE is as follows:

loss=∥x−\hat{x}∥²+KL[N(μₓ,σₓ),N(0,l)]=∥x−d(z)∥²+KL[N(μₓ,σₓ),N(0,l)]

A further description will now be given regarding the second stage.

Learning uncertainty: use PCE as a surrogate model to map the latent space to the output.

Construct polynomials {φₖ}ₖ₌₁^{N}^{ₚ} which are orthogonal with respect to the (VAE prior) standard normal distribution.

$$\\ {c}_{1} , … , {c}_{{N}_{p}} {ℒ}_{{MMD}^{{}^{} 2}} = \frac{1}{{n}^{2}} ( {\sum }_{i , j = 1}^{n} k ( {\tilde{y}}_{i} , {\tilde{y}}_{j} ) - 2 {\sum }_{i , j = 1}^{n} k ( {y}_{i} , {\tilde{y}}_{j} ) + {\sum }_{i , j = 1}^{n} k ( {y}_{i} , {y}_{j} ) ) k$$

Learn PCE coefficients via MMD loss function

$$\\ {c}_{1} , … , {c}_{{N}_{p}} {ℒ}_{{MMD}^{{}^{} 2}} = \frac{1}{{n}^{2}} ( {\sum }_{i , j = 1}^{n} k ( {\tilde{y}}_{i} , {\tilde{y}}_{j} ) - 2 {\sum }_{i , j = 1}^{n} k ( {y}_{i} , {\tilde{y}}_{j} ) + {\sum }_{i , j = 1}^{n} k ( {y}_{i} , {y}_{j} ) ) k$$

(is the Gaussian kernel) to match high order moments of the output distribution to the model response.

$$\\ {c}_{1} , … , {c}_{{N}_{p}} {ℒ}_{{MMD}^{{}^{} 2}} = \frac{1}{{n}^{2}} ( {\sum }_{i , j = 1}^{n} k ( {\tilde{y}}_{i} , {\tilde{y}}_{j} ) - 2 {\sum }_{i , j = 1}^{n} k ( {y}_{i} , {\tilde{y}}_{j} ) + {\sum }_{i , j = 1}^{n} k ( {y}_{i} , {y}_{j} ) ) k$$

Obtain PCE responses \tilde{y}ᵢ=P_{N}_{ₚ}(zᵢ)=Σₖ₌₁^{N}^{ₚ}cₖφₖ(zᵢ).

Infer moments mₖ(\tilde{y}ᵢ|xᵢ)= [symbol] (P_{N}_{ₚ}(zᵢ))^{k}ƒ_{z|x}_{ᵢ}(z)dz.

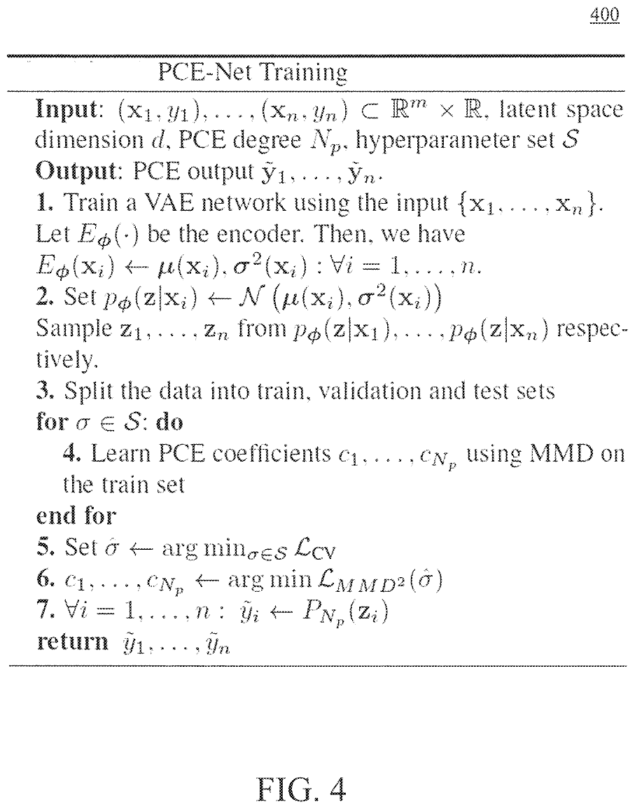

FIG. 4 is a diagram showing exemplary pseudocode 400, in accordance with an embodiment of the present invention.

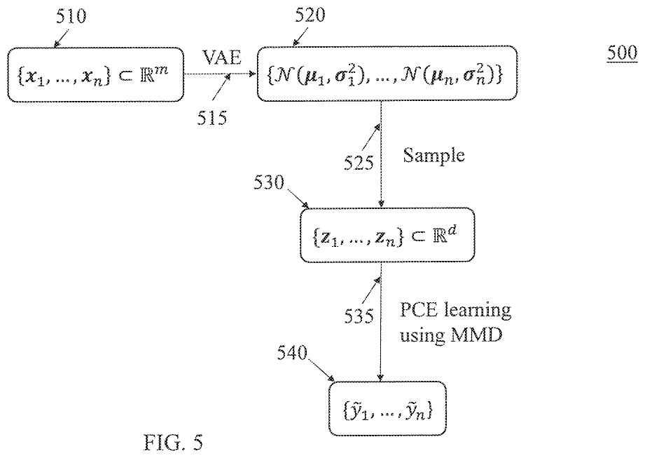

FIG. 5 is flow diagram showing another exemplary method 500 of using a neural network to determine a mapping between data input into a machine learning model and data output from the machine learning model, in accordance with an embodiment of the present invention.

At block 510, {x₁, . . . , xₙ}⊂ [symbol] ^{m}. Block 510 represents the given n high-dimensional input data.

At block 520, { [symbol] (μ₁, σ₁²), . . . , [symbol] (μₙ, σₙ²)}. Block 520 represents the Gaussian distributions learned by the VAE in the latent space (the output of the encoder).

At block 530, {z₁, . . . , zₙ}⊂ [symbol] ^{d}. Block 530 depicts the n low dimensional points sampled in the latent space using the distributions learned by the VAE.

At block 540, {\tilde{y}₁, . . . , \tilde{y}ₙ}. Block 540 shows the output obtained from PCE, where the coefficients are learned using MMD.

Arrow 515 denotes the procedure of using VAE to learn the distributions. Arrow 525 denotes the sampling procedure to obtain the latent space samples. Arrow 535 denotes the process of using PCE and MMD to learn a mapping from the latent space samples to the output.

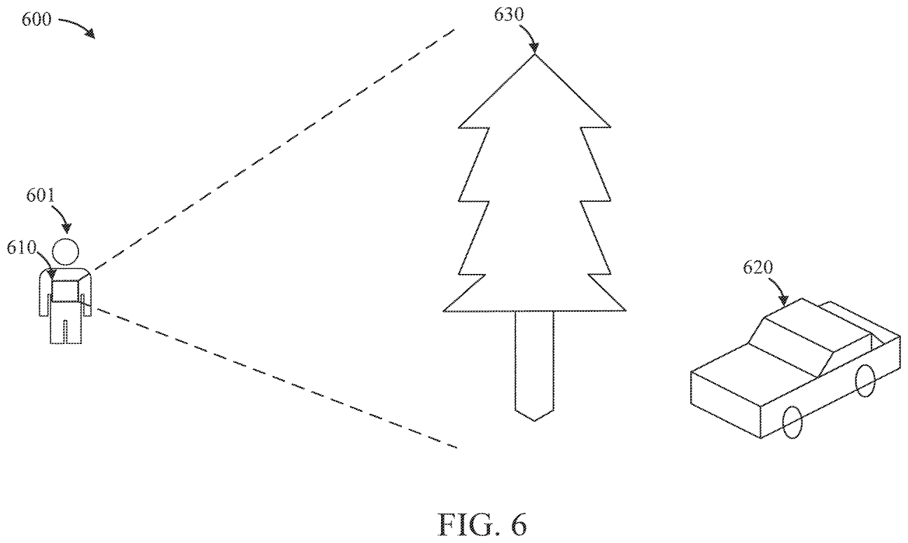

FIG. 6 is a diagram showing an exemplary computer vision scenario 600 to which the present invention can be applied, in accordance with an embodiment of the present invention.

A video camera 610, coupled to a user 601, for example, as a wearable sensor, is used to capture video data including possibly occluded data by a tree 630. In another embodiment, the video camera is operatively coupled to vehicle 620 and is also used to capture video data including possibly occluded data.

In an embodiment, the present invention is used to determine the occluded data thus learning an uncertainty represented in the originally captured video data. In this way, a complete image can be provided to, for example, a vehicle or a blind person in order to avoid a collision and so forth with objects represented by the partially occluded data. In some embodiments, a directional device may be provided to a blind person indicative of the next steps to be taken in view of the image and any possibly occluded items. In this way, the blind person can follow the indications to get around. In the example shown in FIG. 6, a user 601 uses a camera 610 to detect an occluded item (e.g., a car 620) at least partially blocked by a tree 630. In another embodiment, a vehicle can be controlled based on any occluded items in order to avoid a collision by controlling any of a steering, accelerating, braking, and stability system of the vehicle. These and other applications to which the present invention can be applied are readily determined by one of ordinary skill in the art given the teachings of the present invention provided herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

Having thus described aspects of the invention, with the details and particularity required by the patent laws, what is claimed and desired protected by Letters Patent is set forth in the appended claims.

1. A method of mapping high dimensional input data to a low dimensional latent representation to determine data uncertainty, comprising:
receiving, by a computing device, a high dimensional data input and a corresponding data output;
training, by the computing device, a variational autoencoder (VAE) with the high dimensional data input to learn a low dimensional latent space representation of the high dimensional data input, an encoder part of the VAE outputting a set of distributions of the high dimensional dataset in a latent space;
sampling, by the computing device, new data samples in the latent space using the set of distributions outputs from the encoder part of the VAE; and
learning, by the computing device, a polynomial chaos expansion to map the new data samples in the latent space to the corresponding data output to learn the set of distributions and their relation to perform estimation with high-dimensional dataset under uncertainty such as missing values by estimating the values using the set of distributions.

2. The computer-implemented method of claim 1, wherein the polynomial chaos expansion approximates a global behavior of the low dimensional latent space representation using a set of orthogonal polynomials.

3. The computer-implemented method of claim 1, wherein coefficients of the polynomial chaos expansion are learned from a distribution representation of the high dimensional dataset from the set of distributions using a maximum mean discrepancy.

4. The computer-implemented method of claim 3, wherein the coefficients of the polynomial chaos expansion are learned by regression fitting comprising minimizing a loss function.

5. The computer-implemented method of claim 3, wherein the maximum mean discrepancy is used to match high order moments of an output distribution of the data output from the low dimensional latent space representation to a model response of the low dimensional latent space representation.

6. The computer-implemented method of claim 5, further comprising choosing a Gaussian kernel function to capture the high order moments.

7. The computer-implemented method of claim 1, wherein a distribution of the data input into the low dimensional latent space representation and a distribution of the data output from the low dimensional latent space representation are unknown a-priori.

8. The computer-implemented method of claim 1, wherein said sampling step comprises sampling only the latent space without any prior statistical assumptions on the data output from the low dimensional latent space representation.

9. The computer-implemented method of claim 1, wherein the variational autoencoder comprises a neural network based encoder and a neural network based decoder that are jointly optimized in order to maximize an evidence lower bound.

10. A computer program product for mapping high dimensional input data to a low dimensional latent representation to determine data uncertainty, the computer program product comprising a non-transitory computer readable storage medium having program instructions embodied therewith, the program instructions executable by a computing device to cause the computing device to perform a method comprising:
receiving, by the computing device, a high dimensional data input and a corresponding data output;
training, by the computing device, a variational autoencoder (VAE) with the high dimensional data input to learn a low dimensional latent space representation of the high dimensional data input, an encoder part of the VAE outputting a set of distributions of the high dimensional dataset in a latent space;
sampling, by the computing device, new data samples in the latent space using the set of distributions outputs from the encoder part of the VAE; and
learning, by the computing device, a polynomial chaos expansion to map the new data samples in the latent space to the corresponding data output to learn the set of distributions and their relation to perform estimation with high-dimensional dataset under uncertainty such as missing values by estimating the values using the set of distributions.

11. The computer-implemented method of claim 10, wherein the polynomial chaos expansion approximates a global behavior of the low dimensional latent space representation using a set of orthogonal polynomials.

12. The computer-implemented method of claim 10, wherein coefficients of the polynomial chaos expansion are learned from a distribution representation of the high dimensional dataset from the set of distributions using a maximum mean discrepancy.

13. The computer-implemented method of claim 12, wherein the coefficients of the polynomial chaos expansion are learned by regression fitting comprising minimizing a loss function.

14. The computer-implemented method of claim 12, wherein the maximum mean discrepancy is used to match high order moments of an output distribution of the data output from the low dimensional latent space representation to a model response of the low dimensional latent space representation.

15. The computer-implemented method of claim 14, further comprising choosing a Gaussian kernel function to capture the high order moments.

16. The computer-implemented method of claim 10, wherein a distribution of the data input into the low dimensional latent space representation and a distribution of the data output from the low dimensional latent space representation are unknown a-priori.

17. The computer-implemented method of claim 10, wherein said sampling step comprises sampling only the latent space without any prior statistical assumptions on the data output from the low dimensional latent space representation.

18. The computer-implemented method of claim 10, wherein the variational autoencoder comprises a neural network based encoder and a neural network based decoder that are jointly optimized in order to maximize an evidence lower bound.

19. A computer processing system for mapping high dimensional input data to a low dimensional latent representation to determine data uncertainty, comprising:
a memory device for storing program code; and
a hardware processor operatively coupled to the memory device for running the program code to:
receive a high dimensional data input and a corresponding data output;
train a variational autoencoder (VAE) with the high dimensional data input to learn a low dimensional latent space representation of the high dimensional data input, an encoder part of the VAE outputting a set of distributions of the high dimensional dataset in a latent space;
sample new data samples in the latent space using the set of distributions outputs from the encoder part of the VAE; and
learn a polynomial chaos expansion to map the new data samples in the latent space to the corresponding data output to learn the set of distributions and their relation to perform estimation with high-dimensional dataset under uncertainty such as missing values by estimating the values using the set of distributions.

20. The computer processing system of claim 19, wherein coefficients of the polynomial chaos expansion are learned from a distribution representation of the high dimensional dataset from the set of distributions using a maximum mean discrepancy.
